(19) United States
(12) Patent Application Publication
(10) Pub. No.: US 2011/0014546 A1
(43) Pub. Date: Jan. 20, 2011

(54) Nanoporous Silicate Membranes for Portable Fuel

(75) Inventor: Debashis Dutta, Laramie, WY (US)

Correspondence Address: DAVIS, BROWN, KOEHN, SHORS & ROBERTS, P.C.;THE DAVIS BROWN TOWER, 215 10TH STREET SUITE 1300, DES MOINES, IA, 50309, US

(73) Assignee: UNIVERSITY OF WYOMING, Laramie, WY (US)

(21) Appl. No.: 12/670,921

(22) PCT Filed: Jul. 28, 2008
(86) PCT No.: PCT/US08/71352

§ 371 Date: Sep. 9, 2010

Related U.S. Application Data
(60) Provisional application No. 60/962,273, filed on Jul. 27, 2007.

(51) Int. Cl. H01M 8/04

(52) U.S. Cl. 429/512

(57) ABSTRACT

A fuel cell is disclosed which has a significantly reduced internal resistance and which can be miniaturized. Two substrates are prepared, on with microchannels running along its facing surface and the other with nanochannels running along its facing surface. A silica-based binder is used to bind the substrates together with the microchannels running orthogonal to the nanochannels. The binder is removed from the microchannels and a fuel is introduced into at least one of the microchannels and an oxidant is introduced into at least one other of the microchannels.

This application claims priority to U.S. Patent Application Ser. No. 60/962,273, filed Jul. 27, 2007, and incorporated herein by this reference.

### BACKGROUND OF THE INVENTION

The invention relates generally to fuel cells and, more specifically, to fuel cells having nano-scale porous silicate membranes.

A fuel cell is an electrochemical energy conversion device. It produces electricity from external supplies of fuel (on the anode side) and oxidant on the cathode side, which react in the presence of an electrolyte. Fuel cells differ from batteries in that they consume reactants, which must be replenished, while batteries store electrical energy chemically in closed system. Additionally, while the electrodes within a battery react and change as a battery is charged or discharged, the electrodes in a fuel cell are catalytic and relatively stable. Fuel cells are usually compact, lightweight with no moving parts and are very useful as power sources in remote locations. Because fuel cells have no moving parts, and do not involve combustion, they can achieve very high reliability or in other words they have very little down time over their life period. Fuel cells also tend to have much higher efficiencies in converting chemical energy to electrical energy especially when operated under low power density conditions.

The current state-of-art for commercial portable fuel cells consists of primarily two designs. The first among these involve a cathodic and an anodic compartment clamped to each other with a PEM (typically Nafion) sandwiched between them. Such architectures usually have a high electrical resistance dominated by that of the nanoporous Nafion membrane which is typically about 200 microns thick. The other commercial design for portable fuel cell does not require any membrane between the cathodic and the anodic compartment but rely on continuous laminar flow of fluid within it at high speeds (˜1 cm/s) to prevent the fuel and oxidant streams from mixing. Although this design has a much lower electrical resistance, it requires continuous pumping of the fluid via external means. Also, the continuous flow of the oxidant and the fuel in the device allows only about 30% usage of the chemicals yielding low efficiencies.

### SUMMARY OF THE INVENTION

The invention consists of microfluidic fuel cells that include silca based nanoporous/sol-gel structures used as an ion-selective membrane for a polymer electrolyte membrane. Two microchannels are created on a first or bottom glass substrate. A plurality of nanochannels are created on a second or top glass substrate. The microchannels of the substrates are oriented orthogonally relative to the nanochannels and sealed by bonding the two substrates together with a suitable bonding agent, such as sodium silicate. Excess bonding agents is pumped out of the microchannels but remains in the nanochannels where it is transformed into silica gel during curing. A fuel cell fuel fills one of the microchannels and a fuel cell oxidant fills the other of the microchannels.

An object of the present invention is to provide a fuel cell have a low internal resistance.

Another object of the invention is to provide a miniaturized fuel cell that resists leakage of fuel or oxidant.

A further object of the invention is to provide a fuel cell that does not require flowing fuel or oxidant.

### BRIEF DESCRIPTION OF THE DRAWINGS

FIG. 1 is a chart of the performance of a microfluidic fuel cell of the present invention carrying 1M methanol in 0.5M sulfuric acid as the fuel and 0.15M potassium permanganate in 0.5M sulfuric acid as the oxidant at 50° C.; platinum electrodes were employed in both the cathodic and the anodic compartments in these experiments to carry out the electrochemical reactions.

### DETAILED DESCRIPTION OF PREFERRED EMBODIMENTS

This invention disclosure describes the fabrication of silica based nanoporous/sol-gel structures that can be used as an ion-selective membrane or support for a polymer electrolyte membrane (PEM) e.g., Nafion, in portable microfluidic fuel cells. A unit of such a fuel cell comprises of two microchannels that are between about 10 and about 100 microns deep and between about 200 and about 1000 microns wide, created on a glass substrate, preferably using standard photolithographic and wet etching techniques. To seal off these channels a second glass plate is bonded to this substrate using a thin layer of sodium silicate solution, preferably about 5% by weight, as a binder. A series of nanometer scale channels between about 50 and 500 nanometers deep and about 100 and about 500 microns wide, are created on this cover plate prior to the bonding process, preferably by chemical etching. The two plates are brought in contact during the bonding process in such a way that the nanochannels run transverse, and preferably orthogonal, to the microchannels in the bottom substrate. Once the cover plate and the base substrate have been put together excess sodium silicate entering the microchannels are pumped out using a vacuum supply. The solution within the nanometer scale channels however, does not escape due to the large capillary forces. The device is then treated at 90-120° C. in a conventional over under ambient pressure for about 15-30 minutes. During the heating process the sodium silicate solution in the nanochannels turns into silica gel, a porous hard glassy substance. The bonding between the two plates is finally allowed to complete under ambient conditions for about 12 hours. The device is then operated by filling up one of the microchannels with a fuel e.g., 1M methanol in 0.5M sulfuric acid, and other one with an oxidant e.g., 0.15M potassium permanganate in 0.5M sulfuric acid. Upon bringing in contact two platinum electrodes to these fluid streams in the microchannels, a voltage can be generated in the system.

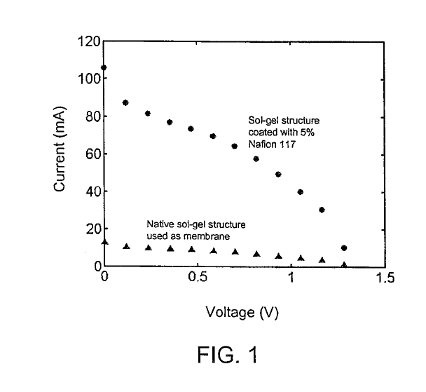

In this circuitry, the porous silicate structure acts as an ion-selective membrane that preferentially allows only cationic/anionic species to pass through it depending on the operating conditions. Scientific literature suggests that this ion-selectivity of silica-based sol-gel structures may be due to the inherent negative charges on their surfaces which tends electrostatically attract only the cationic species towards them. Depending on the solution pH this ion-selectively can be tuned to selectively allow cations or anions to pass through them. In other instances, the sodium silicate derived sol-gel structure can used as a support for a polymer electrolyte membrane that again only allows certain ions to pass through them. In our current work, this has been demonstrated by coating the sot-gel structure with a Nafion solution available commercially. Our data shows the latter design to be more effective due to its lower resistance to ion-conduction yielding in larger currents for a given fuel cell architecture (FIG. 1).

The present invention offers several advantages over the two prior art devices described above. Because the thickness of the nanoporous membrane in the current design can be fabricated down to a size of about 10 micrometers, the internal electrical resistance of the fuel cell is significantly reduced (˜10 Ω). Further, the incorporation of the membrane within the fuel cell allows significant miniaturization of the device and prevents any issues with leakage of the chemicals from the system. Moreover, no flow of the oxidant/fuel is required in this device as the sodium silicate derived membrane prevents their mixing in the system. It is important to note that the current architecture may also allow the integration of multiple fuel cells (scale-up) on a single footprint yielding voltages 1-2 orders of magnitude higher than those could be generated using a single fuel cell. Moreover, because the current device is made from glass-based substrate its optical transparency (compared silicon based devices) can allow the realization solar fuel cells. In these designs, instead of supplying a fuel stream to the microchannels certain proteins/bio-organisms that can utilize solar energy to generate fuels will be placed in the conduits. Also, the requirement of an oxidant stream in these units may be eliminated by bringing in contact the silicate derived membranes to a solution rich in molecular oxygen.

The present invention can have a large impact particularly in running low power devices in remote locations, such as spacecraft, remote weather stations, large parks, rural locations and in certain military applications. It is expected that the simpler fabrication procedure and the requirement of no flow in these devices can significantly reduce the cost involved in producing portable fuel cells and also allow their usage over a wider range of applications, for example, through use of proteins/bio-organisms that can produce fuel using solar energy. Moreover, realization of larger power outputs from these devices through integration of multiple fuel cells in series on a single footprint may allow the realization of high energy portable power sources for the future.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

I claim:

1. A fuel cell, comprising:
(a) a first substrate having at least a pair of microchannels extending along a facing surface thereof;
(b) a second substrate having a plurality of nanochannels extending along a facing surface thereof;
(c) a silica-based binder applied to at least one of the facing surfaces;
(d) the substrates being in contact with each other with the binder between the adjoining facing surfaces with the microchannels transverse to the nanochannels;
(e) wherein the binder is removed from the microchannels; and
(f) a fuel present in at least one of the microchannels and an oxidant present in at least one of the other microchannels.

2. The fuel cell of claim 1, wherein the first and second substrates are glass.

3. The fuel cell of claim 1, wherein the silica-based binder is sodium silicate.

4. The fuel cell of claim 1, wherein the microchannels are between about 10 and about 100 microns deep and between about 200 and about 1000 microns wide.

5. The fuel cell of claim 1, wherein the nanochannels are between about 50 and about 500 nanometers deep and about 100 and about 500 microns wide.
